(19) United States
(12) Patent Application Publication
(10) Pub. No.: US 2007/0299573 A1
(43) Pub. Date: Dec. 27, 2007

(54) ACCELEROMETER BASED SYSTEM FOR DETECTION OF TIRE TREAD SEPARATION AND LOOSE WHEELS

(75) Inventor: Kevin R. Carlstrom, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/426,504

(22) Filed: Jun. 26, 2006

(51) Int. Cl. G06F 19/00

(52) U.S. Cl. 701/29; 701/70

(57) ABSTRACT

Wheel acceleration on a vehicle is measured rotationally and laterally to isolate tire out of round and loose wheel conditions. A wheel accelerometer is mounted outwardly from the axis of rotation to provide both rolling and lateral acceleration measurements. Rotational acceleration should normally be a regular sinusoid under steady state, straight line movement of a vehicle. Lateral acceleration under the same conditions should be zero. Where a wheel is loose a sinusoidal acceleration pattern appears in the direction lateral to the vehicle's direction of travel. Where a portion of a tire is out of round due to physical changes, such as uneven wear or tread separation, the wheel rotational acceleration will assume a spreading frequency other than a simple sinusoid. Appropriate data processing facilities, coupled with wheel rotational speed data from the anti-lock braking system, are used to detect the acceleration changes.

### BACKGROUND OF THE INVENTION

1. Technical Field

The invention relates to a system and method for the detection and possible diagnosis of selected wheel and tire problems by monitoring vehicle wheel acceleration in at least two dimensions.

2. Description of the Problem

Trucks make heavy use of recapped tires, the use of which is uncommon on automobiles. While recapped tires do not as such pose particular safety issues, tires that have not been properly cared for prior to recapping, for example, tires run over temperature or at low pressures for extended periods, can exhibit problems after recapping. Recapped tires then may be subject to tread separation from the casing and the unanticipated loss of tread can pose a road hazard. Of course, a new tire which is subject to such abuse is also subject to tread separation. Wheel separation and loss are also an issue to truck operators.

It is known that impending tire tread separation and loose wheels generate increased and audibly different rolling noise as against good condition tires mounted on solidly attached wheels. Operators are sometimes able to anticipate tread separation and wheel attachment issues because they can hear, or even feel, changes in sound or vibration associated with an impending incident. However, the ambient noise level in a heavy truck is so much higher than that of a car, and the driver frequently so highly isolated from chassis vibration by cab and seat suspension systems, that the occasion of such noise and vibration may easily go unnoticed. Prior art exists which is directed to aiding the operator in hearing changes in rolling noise and to thereby improve operator awareness of impending problems. Representative of this approach is U.S. Pat. No. 5,436,612 to Aduddell. Aduddell proposed installing a microphone assembly on the undercarriage of a truck and trailer to pick up sounds from the rolling assembly to enable transmission and reproduction of the sound in the vehicle cab.

Another approach is that of Lutz et al., U.S. Pat. No. 6,725,136, who recognized that many impending wheel and tire problems are reflected by changes in axle acceleration in the longitudinal, lateral and vertical directions. Lutz provided an accelerometer for each wheel of a vehicle, with the accelerometers mounted at the axle ends. By so positioning the accelerometers Lutz proposed to identify developing problems in tires, wheels and the vehicle's suspension and to ease installation of the system. However, by measuring axle acceleration instead of wheel acceleration, the detection of the certain tire and wheel issues can be obscured, particularly where dual wheels are installed on each end of an axle.

### SUMMARY OF THE INVENTION

According to the invention there is provided a system for measuring wheel acceleration on a vehicle. More particularly, the system provides for measuring wheel acceleration in at least two dimensions. Wheel acceleration in the lateral direction is used for determining wheel sway associated with a loose wheel condition. Wheel rotational acceleration is monitored to determine rhythmic changes in wheel rotational speed which are associated with tread separation and other out of round conditions of the tire other than those associated with tire pressure. Under steady state, straight line rolling conditions an accelerometer mounted on a wheel outwardly from its axis of rotation should exhibit no lateral acceleration and a regular sinusoidal rotational acceleration. Where a wheel is loose a sinusoidal acceleration pattern appears in the direction lateral to the vehicle's direction of travel. Where a portion of a tire is out of round due to physical changes, such as uneven wear or tread separation, wheel rotational acceleration will assume frequency components other than those of a simple sinusoid. Appropriate data processing facilities, coupled with wheel rotational speed data from the anti-lock braking system, are used to detect the acceleration changes.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic of a vehicle drive train for a truck tractor.

FIG. 2 is a high level schematic of a vehicle control system.

FIG. 3 is a circuit analogy for determination of a fault condition based on wheel rotational acceleration.

FIGS. 4A-C are graphs illustrating isolation of out of norm acceleration.

FIG. 5 is a circuit analogy for determination of a fault condition based on lateral acceleration of a wheel.

FIG. 6 is a graphical illustration of lateral acceleration fault state.

### DETAILED DESCRIPTION OF THE INVENTION

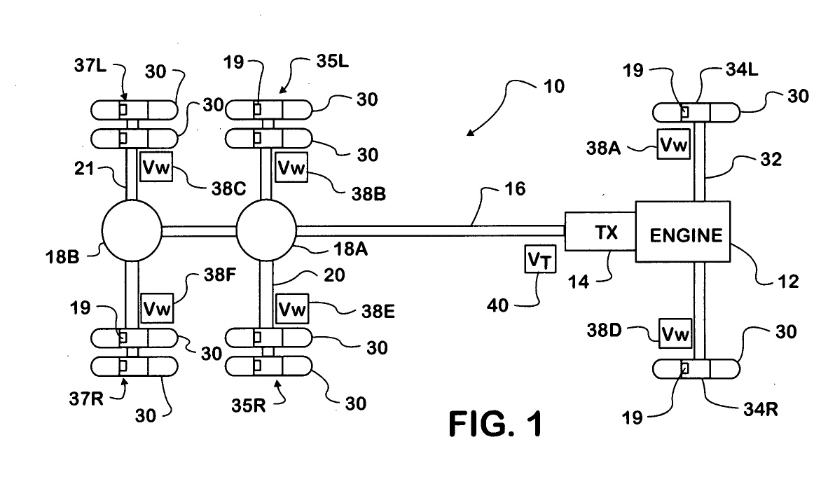

Referring now to the drawings, a preferred embodiment of the invention and its manner of use will be described. FIG. 1 illustrates a vehicle drive train 10 to which the system and method of the invention are applied. Vehicle drive train 10 provides for the application of motive power generated by an engine 12 to each of a plurality of dual rear drive wheel assemblies including 35R and 35L, installed on the ends of drive axle 20, and dual rear drive wheel assemblies 37R and 37L, installed on the ends of drive axle 21. Each dual drive wheel assembly includes an inner and an outer wheel, each of which has a tire 30 mounted thereon (for eight tires). Each dual rear drive wheel assembly has an accelerometer 19 installed on both its inner and outer wheel. A front steering axle 32 is provided with wheels 34R and 34L, each having an accelerometer 19 installed thereon and a tire 30 mounted thereto. The accelerometers 19 are installed on the wheels at locations spaced a known distance from the axis of rotation of the drive wheel assemblies. The accelerometers 19 measure both rotational acceleration and lateral acceleration. The rear drive wheels are powered by a drive shaft 16 connecting rear differentials 18A and 18B to transmission 14. Vehicle speed may be measured by provision of a transmission tachometer 40. The illustration of the invention with what is in essence a tractor wheel configuration in no way limits its application to other situations, including trailers. The drive train illustrated may be generalized to cover other types of running gear.

The vehicle incorporating vehicle drive train 10 is equipped with an antilock braking system (ABS) which provides wheel speed sensors for the wheels, or pairs of dual mount wheels. These include a wheel rotational speed sensor 38A positioned adjacent and on left forward wheel 34L and wheel rotational speed sensor 38D adjacent right forward wheel 34R. Similarly, rotational speed sensor 38B is adjacent dual wheel assembly 35L, rotational speed sensor 38C is adjacent dual wheel assembly 37L, rotational speed sensor 38E is adjacent dual wheel assembly 35R and rotational speed sensor 38F is adjacent dual wheel assembly 37R. Wheel speed sensors may be provided for only one of two tandem drive axles, in which case the rotational speed measurement for the wheels mounted on the axle missing sensors are taken from the axle having sensors. Vehicle speed may also be generated from a tachometer 40 mounted to the output end of transmission 14. The signal generated from tachometer 40 represents an average of the rotational velocity of the vehicle's rear wheel assemblies. Using the tachometer vehicle speed is generated by factoring the tachometer's output by a standard wheel radius and the step down ratio of the rear differentials to produce a desired speed. However, as is well known, rear drive wheels are subject to mutually-differing slippage during acceleration (and deceleration) and in climbing and descending from hills, among other situations. Accordingly, the speed signal produced by tachometer 40, being an average for all the drive wheels, is not the most accurate way to measure vehicle speed much less the rotational speed of individual wheels, though it remains commonly employed. Preferably ABS sensors 38A-F are used for gathering data for wheel rotational velocities.

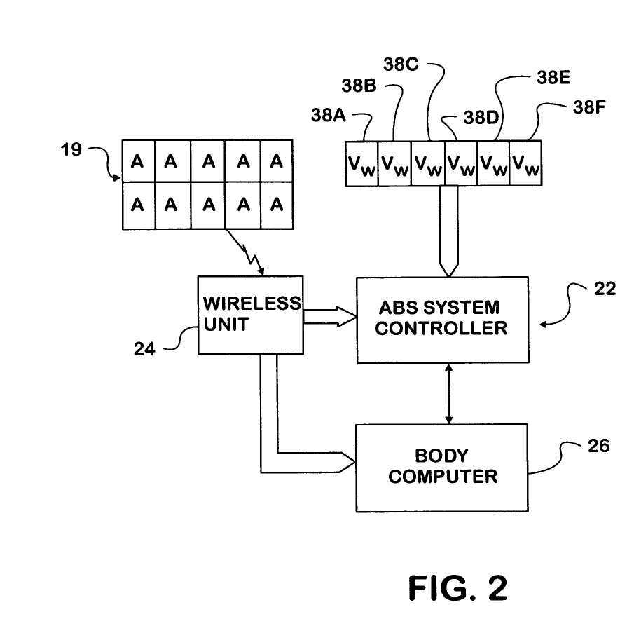

In the preferred embodiment of the invention a vehicle ABS system 22 as illustrated in FIG. 2 is used for obtaining the rotational speed of each wheel or wheel assembly using the six rotational speed sensors 38A through 38F. Wheel acceleration data is generated by the ten accelerometers 19 mounted with respect to each wheel including each of the two wheels in dual mounted pairs. Accelerometers 19 are wireless devices and signals therefrom are received by a wireless receiver 24 which is coupled to the ABS system controller 22 or to body computer 26. ABS system controller 22 may be adapted to handle the additional data stream representing acceleration data and to format the data for transmission to a body computer 26 or the signals may be supplied directly to body computer 26. The measurements generated by rotational speed sensors 38A-F and accelerometers 19 are all collected by body computer 26 for determination of rotational and lateral acceleration indicative of tire and wheel problems.

The placement of the two axis accelerometers 19 on the wheels, displaced a predetermined distance from axis of rotation of the wheels, allows the accelerometers to detect rotational acceleration and lateral acceleration of the wheels. At a constant vehicle speed in a straight line, or steady state turn, the wheels should exhibit, at any fixed point on the wheel which is displaced from the axis of rotation, a fixed point rotational velocity which varies sinusoidally. Accordingly, the rotational acceleration profile at the same point will also vary sinusoidally, with a phase difference of 90 degrees from the rotational velocity profile (i.e. the acceleration profile is the cosine of the velocity profile). For vehicle movement in a straight line, whether vehicle velocity is constant or not, lateral acceleration at the same point should be zero. Because vehicle velocity is known either from a transmission tachometer 40 or from the ABS system controller 22, the anticipated acceleration profile for the wheels can be generated. Using the ABS system controller 22 is preferred because it can provide rotational speeds which are directly measured for each wheel (or dual wheel pair). As already noted, the transmission tachometer 22 in effect provides only an average rotational speed for the drive wheels.

In theory, the time derivative of the individual wheel velocity signals could serve as a substitute for a rotational accelerometer. However, the velocity sensors 38A-F of ABS controller system 22 would not be likely to be sensitive enough to detect brief transients in wheel speed to due out of round conditions of tires 30 because such tire defects will often extend to only a small part of the circumference of the vehicle. The radial extent of the defect could even be less than the radial resolution of the ABS velocity sensor. Thus where only a part of the rolling radius is effected it would be difficult to obtain a useful acceleration profile by taking the time derivative of the wheel velocity signals. It would be still more difficult when dealing with dual wheels because the effect would be partially masked by absence of the defect from one of the two tires.

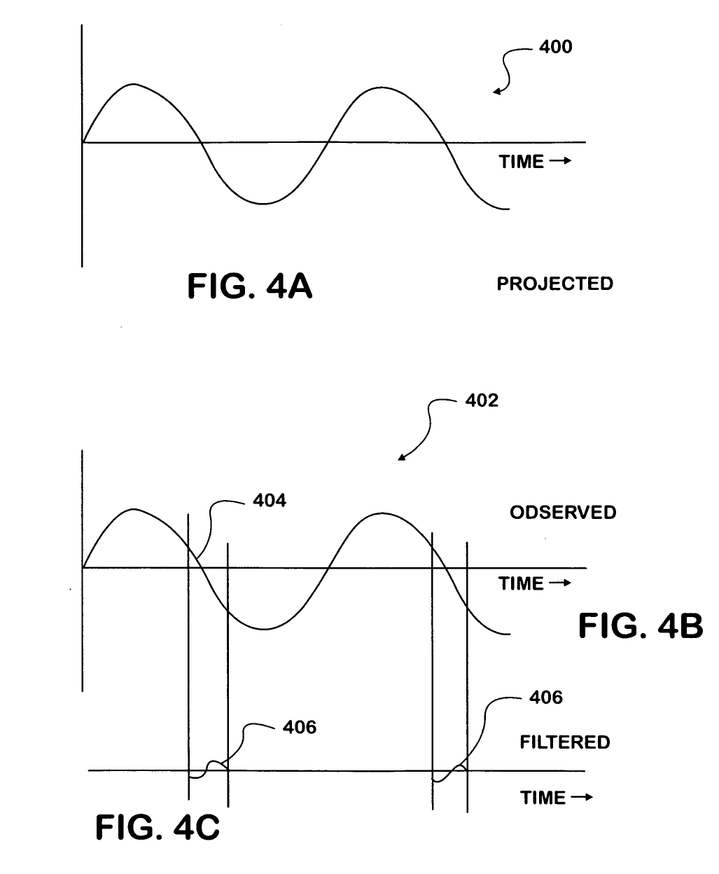

Referring to FIGS. 4A-C examples of rotational acceleration profiles for a particular wheel are considered. FIG. 4A illustrates a conventional sine wave 400 of constant amplitude, a characteristic profile for acceleration at a fixed point on a wheel where the tire is not out of round. Such a curve can be predicted where the rotational velocity of the wheel in question is already known. In FIG. 4B an observed acceleration profile 402 is illustrated exhibiting a periodic variation 404 in the acceleration profile indicative of an out of round tire condition. FIG. 4C reflects canceling combination of the predicted curve 400 from the observed curve 402 to produce a periodic signal 406, which is the unanticipated portion of the acceleration profile. Such filtering may be useful in determining a likely cause of the unusual profile, since it eliminates the distraction of the relative radial displacement of the defect relative to the position of the accelerometer 19. Requiring periodicity, particularly periodicity with a frequency harmonized to the rotational velocity, should limit or eliminate indications of tire defects stemming from exogenous shocks to the tires, even where coming from highway pavement expansion cracks.

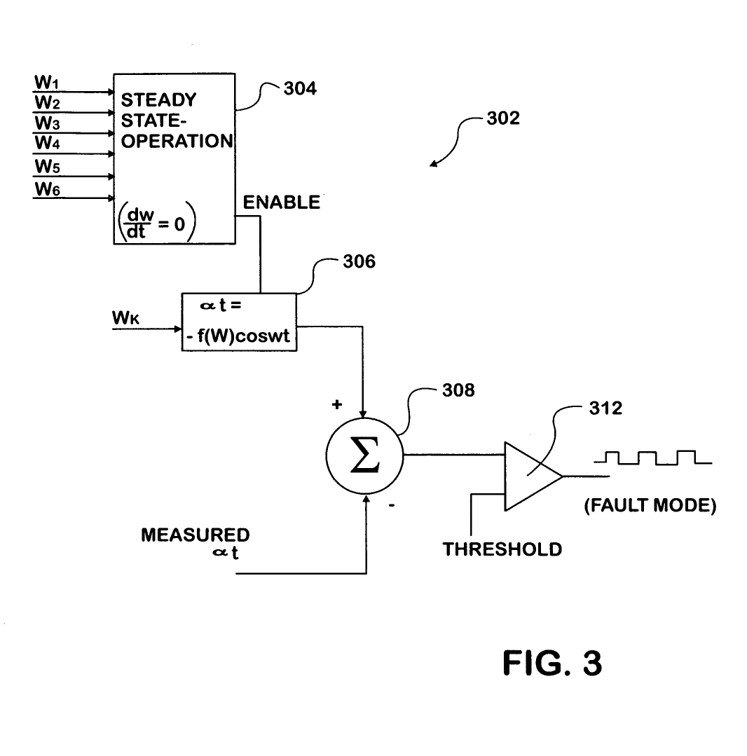

Referring to FIG. 3, a circuit analogy for analysis of rotational acceleration, providing for isolation of undesired rotational acceleration, is illustrated. It will be understood by those skilled in the art that the process represented by the circuit 302 may be implemented by programming of a digital computer, such as body computer 26. On a three axle vehicle such as illustrated by drive train 10 in FIG. 1, up to six wheel velocity measurement signals T may be available, though typically only four signals are available. Box 304 provides for determining from the velocity signals if the vehicle is in a steady state operating mode. If a transmission tachometer is used there would be only one velocity signal input, but other inputs may be desirable to assure that the vehicle is operating in a straight line. Box 304 provides an enable signal when the necessary conditions are met, which is shown as applied to box 306 (but which also might be applied to comparator 312). Wheel rotational velocity could also be derived from the integral over time of the rotational acceleration signals. However, the use of accelerometers to determine wheel rotational speed during skidding might lead to ambiguous results.

Box 306 operates on an observed rotational velocity signal for a given wheel (where available from an ABS system controller 22) to generate an anticipated sinusoidal acceleration profile 400 at the location of the accelerometer 19 on the wheel. Though not shown, the observed acceleration profile and the anticipated acceleration profile may be periodically synchronized. The anticipated acceleration profile and the observed acceleration profile provide the input to a summer 308 with the remainder, or deviance curve, from the summer providing one of two inputs to a comparator 312. The second input is a threshold signal which in effect, allows determination of the energy level in the unanticipated acceleration profile. A non-zero recurring output from the comparator 312 indicates a likely out of round tire condition which may be indicated to the vehicle operator in conventional fashion. The output frequency of the pattern associated with problem should match the rotational frequency of the wheel.

With empirical research it may be possible to subject a curve such as curve 406 to a frequency analysis to determine what sort of out of round condition is the likely cause of the deviation. In such cases the simple threshold comparison test represented by comparator 312 would be displaced by frequency analysis testing.

It is also possible to dispense with generating an anticipated acceleration profile from wheel rotational velocity and to subject the measured acceleration profiles to direct analysis for departures from an expected sinusoidal shape. The generation of an anticipated curve is just one technique of eliminating the expected frequency component in the measured curve.

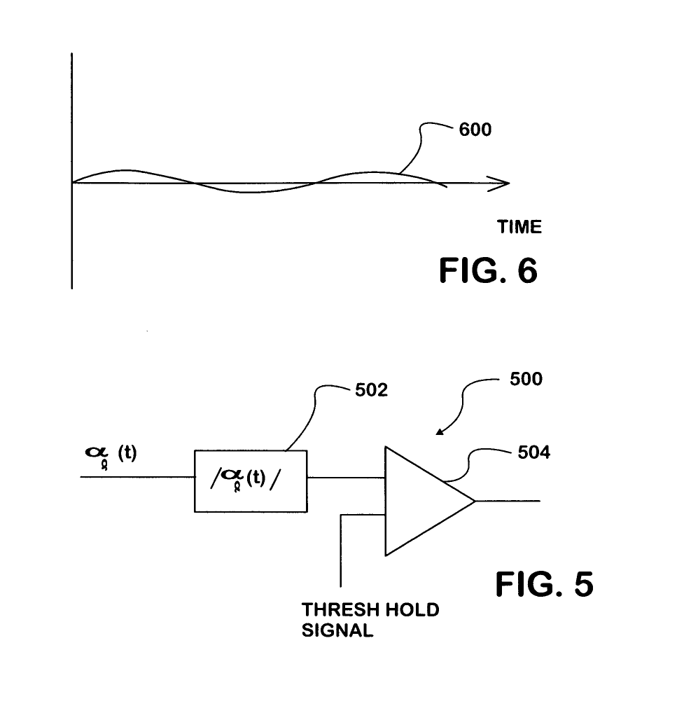

FIG. 6 illustrates a lateral acceleration profile 600 generated by an accelerometer 19 in response to a wheel which is swaying to and fro, which can result from a number of causes, such as a bent axle or a loose wheel. Where the amplitude of the profile increases with the time the most usual cause is a progressively looser wheel, particularly where the sinusoidal curve appears for only one of two wheels in a tandem pair. Detection of such a development is simpler than that of an out of round tire condition. As illustrated in FIG. 5, an analogous circuit 500 provides for comparing the observed acceleration signal to a comparator 504 which generates a periodic signal as soon as the amplitude of the acceleration profile 600 exceeds a minimum. The analogous circuit 500 includes an element 502 which full wave rectifies the signal to produce a more continuous output from comparator 504, if desired.

The present invention provides a tool for identification of certain tire and wheel defects, avoiding the problems posed particularly by tandem wheel arrangements in isolating such issues.

While the invention is shown in only one of its forms, it is not thus limited but is susceptible to various changes and modifications without departing from the spirit and scope of the invention.

What is claimed is:

1. Vehicle running gear comprising:
a plurality of wheels mounted for rotation;
tires installed on the plurality of wheels;
an accelerometer installed on each of the plurality of wheels providing measurements of wheel rotational and lateral acceleration;
data processing means coupled to receive the measurements of wheel rotational and lateral acceleration when the wheels are rotating, the data processing means providing for determining non-zero lateral acceleration indicating a wheel mounting problem and for determining rotational acceleration components other than an expected sinusoidal component indicating out of round tire conditions.

2. A vehicle drive train as claimed in claim 1, further comprising:
the data processing means being programmed to determine the presence of lateral acceleration exhibiting a sinusoidal profile as indication of a loose wheel.

3. A vehicle drive train as claimed in claim 1, further comprising:
the data processing means being programmed to determine the occurrence of rhythmic changes in wheel rotational speed other than a pure sinusoid and associating such with a tire defect such as impending tread separation.

4. A vehicle drive train as claimed in claim 3, further comprising:
a vehicle anti-lock brake system providing rotational velocity measurement for each of the plurality wheels; and
the data processing means being further programmed to generate a nominal acceleration profile for each wheel in response to the rotational velocity measurement for each wheel.

5. A vehicle drive train as claimed in claim 4, further comprising:
the data processing means providing for comparing the nominal acceleration profile for a wheel with the measured rotational acceleration profile for the same wheel to determine recurring transient acceleration events indicative of a tire problem associated with the wheel.

6. A method of detecting operational faults in tires and wheels of a motor vehicle, the method comprising the steps of:
measuring the rotational acceleration of the wheels at a reference point for each wheel;
measuring the lateral acceleration of the wheels;
detecting recurring transient deviations of the measured rotational acceleration;
evaluating the deviations for amplitude and period as an indicator of a tire defect; and
evaluating the measured lateral acceleration for period and deviation from a zero value as an indicator of a non-nominal wheel condition.

7. A method of detecting operational faults in tires and wheels of a motor vehicle as set forth in claim 6, the step of detecting includes:
measuring the rotational velocity of the wheels;
responsive to the measured rotational velocity for each wheel generating a nominal acceleration profile for the wheel at the reference point; and
comparing the nominal acceleration profile with the measured rotational acceleration profile for a wheel to generate a deviance curve indicative of possible tire defects.

8. A wheel and tire monitoring system for a vehicle comprising:
rotational and lateral accelerometers mounted with respect to and spaced from the axis of rotation of each wheel to be monitored; and
data processing means coupled to receive the measurements of the rotational and lateral accelerometers, the data processing means providing for determining periodic non-zero lateral acceleration events indicating a wheel mounting problem and for determining rotational acceleration components outside an expected sinusoidal profile indicating a tire problem.

9. A wheel and tire monitoring system for a motor vehicle as set forth in claim 8, further comprising:
the data processing means being programmed to generate a nominal acceleration profile for each wheel.

10. A wheel and tire monitoring system for a motor vehicle as set forth in claim 9, further comprising:
an anti-lock brake system providing individual wheel rotational velocity measurements to the data processing means; and
the data processing means being responsive to the wheel rotational velocity measurements for generating a nominal acceleration profile for each wheel for comparison to the measurements of the rotational and lateral accelerometers.

11. A wheel and tire mounting system for a motor vehicle as set forth in claim 10, further comprising:
an anti-lock brake system for receiving measurement signals from the accelerometers and providing the measurements to the data processing means.
